(19) United States
(12) Patent Application Publication
(10) Pub. No.: US 2017/0197332 A1
(43) Pub. Date: Jul. 13, 2017

(54) FORMING PATTERN IN CONCRETE STRUCTURE USING MIXTURE OF SILICON AND CEMENT

(71) Applicant: ILJIN PATTERN CONSTRUCTION CO., LTD., Seoul (KR)

(72) Inventor: Gugbea EUM, Seoul (KR)

(73) Assignee: ILJIN PATTERN CONSTRUCTION CO., LTD., Seoul (KR)

(21) Appl. No.: 15/320,491

(22) PCT Filed: Apr. 27, 2016
(86) PCT No.: PCT/KR2016/004402

§ 371 Date: Dec. 20, 2016

(30) Foreign Application Priority Data
May 19, 2015 (KR) 10-2015-0069726

(51) Int. Cl. B28B 7/00; B28B 3/02; B28B 1/14; E04G 13/02; E04G 9/10; E04B 2/84; E04B 1/20; E04G 11/06; B28B 7/38; B28B 11/24

(52) U.S. Cl. CPC B28B 7/0064; B28B 7/384; B28B 3/02; B28B 1/14; B28B 11/245; E04G 9/10; E04B 2/84; E04B 1/20; E04G 11/06; E04G 13/021; E04G 17/14

(57) ABSTRACT

There is provided a method for forming a pattern or a shape in a concrete wall structure, the method comprising: mixing a cement about 100% by weight and silicon about 50% by weight to form a mixed silicon; inserting the mixed silicon into a forming frame; pressing a pressing member onto the first surface and removing the pressing member from the first surface; attaching the forming frame onto the form; placing and curing a concrete to the surface of the mixed silicon in which the shape or pattern is defined; and removing the mixed silicon from the cured concrete, thereby to obtain a concrete wall structure having the three-dimensional pattern or shape formed therein.

### BACKGROUND

Field of the Present Disclosure

The present disclosure relates to a method for forming a pattern or a shape in a concrete pillar or wall structure using a mixture of cement and silicon.

Discussion of the Related Art

Generally, the concrete structure may have a pattern or shape formed thereon. Further, the pattern or shape may have a color using a color paint. The pattern or shape may be convex.

Recently, a separate pattern or shape may be attached to the wall or pillar. When the separate pattern or shape is attached to the wall or pillar, the pattern or shape may be detached from the concrete structure.

When a form mold for a concrete is used for forming the shape or pattern, the shape or pattern may be monolithic with the concrete structure. Thus, the separation between the pattern or shape and the concrete structure may be suppressed. For this, the form mold for a concrete may be shaped or patterned using a computer number control (CNC). This may have a limitation in increasing the size of the pattern or shape. Further, this may have limitation in forming a three-dimensional pattern or shape. When a form mold for a concrete is used for forming the shape or pattern, the shape or pattern formed on the concrete structure may be damaged due to a hard property thereof when the cured concrete is removed from the form mold.

### SUMMARY

Thus, the present disclosure provides a method for forming a pattern or a shape in a concrete pillar or wall structure using a mixture of cement and silicon, thereby to form a large shape or pattern and/to prevent the shape or pattern formed on the concrete structure from being damaged when the cured concrete is removed from the form mold.

Further, the present disclosure provides a method for forming a pattern or a shape in a concrete pillar structure using a mixture of cement and silicon and a cloth cover, thereby to allow a formation of sophisticated patterns or shapes on the pillar structure.

In one aspect, there is provided a method for forming a pattern or a shape in a concrete wall structure, the method comprising: (a) mixing a cement about 100% by weight and silicon about 50% by weight to form a mixed silicon; (b) inserting the mixed silicon into a forming frame; (c) applying a separating agent on a first surface of the mixed silicon in the forming frame wherein the first surface is exposed; (d) pressing a pressing member onto the first surface and removing the pressing member from the first surface, thereby to form a three-dimensional pattern or shape in the mixed silicon, wherein the pressing member has the three-dimensional pattern or shape defined therein; (e) providing a form for a concrete; (f) attaching the forming frame onto the form; (g) applying a concrete releaser onto a surface of the mixed silicon in which the shape or pattern is defined; (h) placing and curing a concrete to the surface of the mixed silicon in which the shape or pattern is defined; and (i) removing the mixed silicon from the cured concrete, thereby to obtain a concrete wall structure having the three-dimensional pattern or shape formed therein.

In one implementation, the forming frame is made of an iron, wherein the forming frame has a cross-sectional shape including a polygonal shape.

In one implementation, the (b) comprises inserting the mixed silicon into a plurality of forming frames, wherein the (d) comprises pressing a plurality of pressing members onto the mixed silicon in the forming frames respectively.

In one implementation, the (f) comprises attaching the forming frames onto the form F on the inner face of the form.

In one implementation, the method further comprises filling a leveling material into an inner face region of the form in which the forming frame is not attached, wherein a level of the leveling material is substantially equal to that of the forming frame.

In one implementation, the method may further comprise filling a leveling material into an inner face region of the form F in which the forming frames are not attached, wherein a level of the leveling material is substantially equal to that of the forming frame.

In one implementation, when the wall structure is newly formed, the frame is sandwiched between two forms while one form is spaced from the surface of the mixed silicon in which the pattern or shape is formed during the (f) operation.

In one implementation, when the pattern or shape is formed into an existing wall structure, the form is adjacent to the existing wall while the wall is spaced from the surface of the mixed silicon in which the pattern is formed during the (f) operation.

In another aspect, there is provided a method for forming a pattern or a shape in a concrete pillar structure, the method comprising: (a) mixing a cement about 100% by weight and silicon about 50% by weight to form a mixed silicon; (b) inserting the mixed silicon into a forming frame; (c) applying a separating agent on a first surface of the mixed silicon in the forming frame wherein the first surface is exposed; (d) pressing a pressing member onto the first surface and removing the pressing member from the first surface, thereby to form a three-dimensional pattern or shape in the mixed silicon, wherein the pressing member has the three-dimensional pattern or shape defined therein; (e) providing a cover cloth having top and bottom margins extending beyond a top and bottom of the pillar structure respectively; (f) attaching the forming frame onto the cover cloth; (g) providing a pillar forming framework having a shape corresponding to a shape of the pillar structure; (h) wrapping the cover cloth around the pillar forming framework; (i) providing a pillar shaped form around the cover cloth wherein the pillar shaped form contacts the cover cloth; (j) turning the top and bottom margins inside out and fixing the top and bottom margins to a top and bottom of the form respectively; (k) filling and curing a concrete into the pillar forming framework; and (l) removing the form from the cover cloth and then removing the cover cloth from the forming frame and then removing the forming frame from the cured concrete, thereby to obtain the concrete pillar structure having the three-dimensional pattern or shape formed therein.

In one implementation, the cover cloth has a pair of coupling means, each extending between the top and bottom of the cloth.

In one implementation, the (h) comprises wrapping the cover cloth around the pillar forming framework in an enclosing manner by the pair of coupling means being vertically coupled to each other.

In one implementation, the forming frame is made of an iron, wherein the forming frame has a cross-sectional shape including a polygonal shape.

In one implementation, the (b) comprises inserting the mixed silicon into a plurality of forming frames, wherein the (d) comprises pressing a plurality of pressing members onto the mixed silicon in the forming frames respectively.

In one implementation, the (f) comprises attaching the forming frames onto the cover cloth.

In one implementation, the method may further comprise filling a leveling material into a region of the cover cloth in which the forming frame is not attached, wherein a level of the leveling material is substantially equal to that of the forming frame.

In one implementation, the method may further comprise filling a leveling material into a region of the cover cloth in which the forming frames are not attached, wherein a level of the leveling material is substantially equal to that of the forming frame.

In one implementation, the pillar shaped form is formed of a PVC tube or circular pipe.

In accordance with the present disclosure, the following effects may be achieved without limitation:

Using the mixed silicon, the sophisticated pattern or shape may be formed in the concrete structure. Due to the fact that the mixed silicon is obtained with a mixture ratio 1:2 of the silicon and cement, the mixed silicon may be inexpensive, and the mixed silicon may behave like a clay to allow a fine formation. Using the cloth cover, the pattern or shape may be reliably formed on the pillar. That is, without a septate equipment, the pattern or shape may be reliably formed on the pillar.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 shows a process for forming a pattern or shape in a concrete wall structure using a mixed silicon in accordance with one embodiment of the present disclosure.

FIG. 2 shows a method for forming a pattern or shape in a concrete wall structure using a mixed silicon in accordance with another embodiment of the present disclosure.

FIG. 3 shows a method for forming a pattern or shape in a concrete wall structure using a mixed silicon in accordance with another embodiment of the present disclosure.

FIG. 4 and FIG. 5 show a process for forming a pattern or shape in a concrete pillar structure using a mixed silicon in accordance with one embodiment of the present disclosure.

FIG. 6 shows a method for forming a pattern or shape in a concrete pillar structure using a mixed silicon in accordance with another embodiment of the present disclosure.

### DETAILED DESCRIPTIONS

Examples of various embodiments are illustrated in the accompanying drawings and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

Further, the use of “may” when describing embodiments of the present disclosure refers to “one or more embodiments of the present disclosure.”

Hereinafter, embodiments of the present disclosure will be described in details with reference to attached drawings.

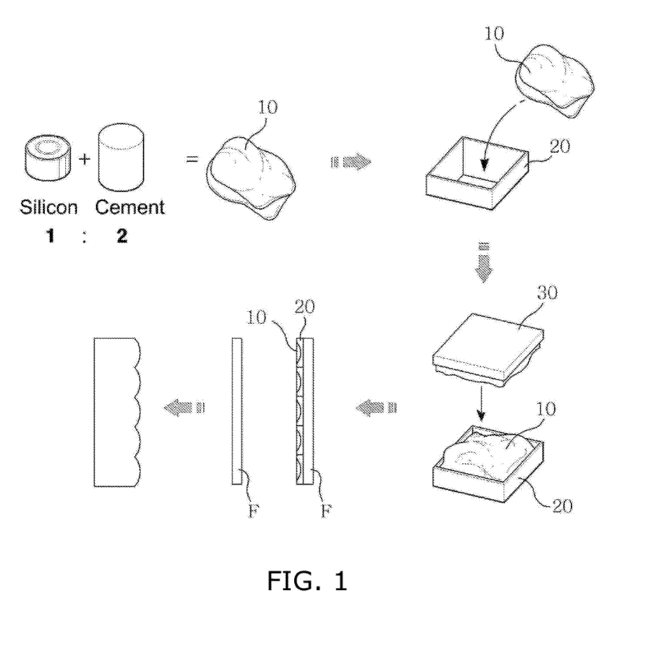

FIG. 1 shows a process for forming a pattern or shape in a concrete wall structure using a mixed silicon 10 in accordance with one embodiment of the present disclosure.

The present disclosure may be applied to a wall concrete structure to form a pattern or shape therein. In this embodiment, there is provided the method for forming a pattern or a shape in a concrete wall structure, the method comprising: (a) mixing a cement about 100% by weight and silicon about 50% by weight to form a mixed silicon 10; (b) inserting the mixed silicon 10 into a forming frame 20; (c) applying a separating agent on a first surface of the mixed silicon 10 in the forming frame 20 wherein the first surface is exposed; (d) pressing a pressing member 30 onto the first surface and removing the pressing member 30 from the first surface, thereby to form a three-dimensional pattern or shape in the mixed silicon, wherein the pressing member has the three-dimensional pattern or shape defined therein; (e) providing a form F; (f) attaching the forming frame 20 onto the form F; (g) applying a concrete releaser onto a surface of the mixed silicon in which the pattern or shape is formed; (h) placing and curing a concrete to the surface of the mixed silicon in which the pattern or shape is formed; and (i) removing the mixed silicon 10 from the cured concrete, thereby to obtain a concrete wall structure having the three-dimensional pattern or shape formed therein.

First, the mixed silicon 10 may be formed by mixture of the cement 100% by weight and silicon 50% by weight. This mixed silicon 10 may be inexpensive compared to a conventional forming silicon. The mixed silicon 10 may be formed by a mixture of the cement and silicon with a ratio of 2:1. With the mixture ratio, the cement and silicon may be mixed and kneaded and shaped like a clay and then may be cured after about 24 hours. The cured mixture may have a behavior like a rubber.

The forming frame 20 to receive therein the mixed silicon 10 may be made of a metal such as an iron. After the mixed silicon 10 has a shape or pattern defined therein at an exposed face while being received in the forming frame 20, the forming frame 20 may be attached to the form F. The forming frame 20 has a rectangular shape as shown in FIG. 1. The present disclosure may not be limited thereto. The forming frame 20 has various polygonal shapes. The forming frame 20 may have a flat face coupled to the form F.

The pressing member 30 may act to form a pattern or shape into the mixed silicon 10 via a pressing. The pressing member 30 may be made of a wood or stone. The exposed face of the mixed silicon 10 may have a separating agent applied thereto. This may facilitate a separation between the pressing member 30 and the mixed silicon 10. The separating agent may include a lubricant or wax. The pressing member 30 may have a three-dimensional shape or pattern as designed by a user. The three-dimensional shape or pattern may be convex.

In the present disclosure, the mixed silicon 10 may be particulate. Thus, the mixed silicon 10 may allow a formation of a thick pattern above 10 cm or a fine pattern. The mixed silicon 10 may be cheap, to allow a formation of a grand sized pattern.

When a wall structure is newly formed, the frame 20 may be sandwiched between two forms F while one form F is spaced from the surface of the mixed silicon in which the pattern is formed. When a pattern or shape is formed into an existing wall structure, the form F may be adjacent to the wall while the wall is spaced from the surface of the mixed silicon in which the pattern is formed.

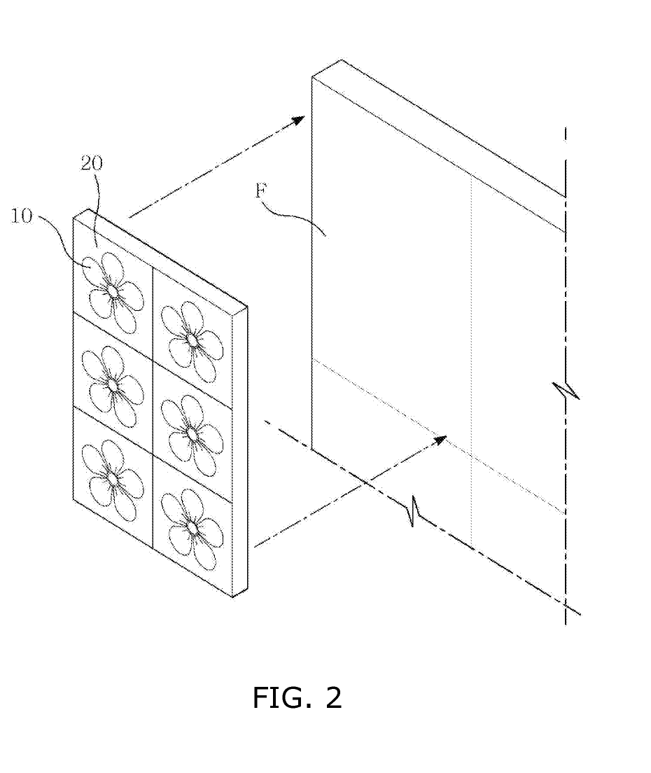

FIG. 2 shows a method for forming a pattern or shape in a concrete wall structure using a mixed silicon 10 in accordance with another embodiment of the present disclosure. As shown in FIG. 2, in this embodiment, there is provided the method for forming a pattern or a shape in a concrete wall structure, the method comprising: (a) mixing a cement about 100% by weight and silicon about 50% by weight to form a mixed silicon 10; (b) inserting the mixed silicon 10 into a plurality of forming frames 20; (c) applying a separating agent on a first surface of the mixed silicon 10 in the forming frames 20 wherein the first surface is exposed; (d) pressing a plurality of pressing members 30 onto the first surface of the mixed silicon 10 in the plurality of forming frames 20 respectively and removing the pressing members 30 from the first surface, thereby to form a three-dimensional pattern or shape in the mixed silicon, wherein the pressing member has the three-dimensional pattern or shape defined therein; (e) providing a form F having an inner space therein; (f) attaching the forming frames 20 onto the form F on an inner face of the form F; (g) applying a concrete releaser onto an exposed inner face of the form F; (h) filling and curing a concrete into the inner space; (i) removing the form F from the cured concrete; and (j) removing the forming frames 20 from the form F, thereby to obtain a concrete structure having the three-dimensional pattern or shape formed therein. In this embodiment, the plurality of forming frames 20 may be employed to shorten a formation time of the pattern or shape. As shown in FIG. 2, six forming frames 20 are employed. The present disclosure is not limited thereto. The number of the forming frames 20 as employed may vary depending on a design requirement or construction circumstance.

The forming frames 20 receiving the mixed silicon 10 may be attached collectively onto the form F. The forming frames 20 may be bonded to the form F using a tacker. A conventional silicon may be filled into between adjacent forming frames 20 to prevent a gap therebetween.

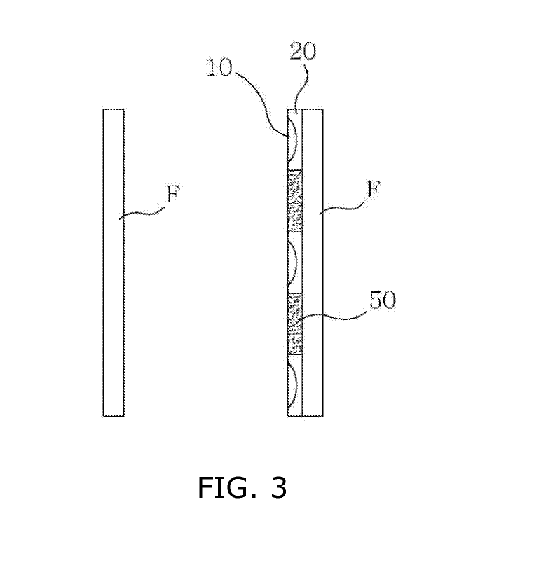

FIG. 3 shows a method for forming a pattern or shape in a concrete wall structure using a mixed silicon 10 in accordance with another embodiment of the present disclosure. As shown in FIG. 3, in this embodiment, there is provided the method for forming a pattern or a shape in a concrete wall structure, the method comprising: (a) mixing a cement about 100% by weight and silicon about 50% by weight to form a mixed silicon 10; (b) inserting the mixed silicon 10 into a plurality of forming frames 20; (c) applying a separating agent on a first surface of the mixed silicon 10 in the forming frames 20 wherein the first surface is exposed; (d) pressing a plurality of pressing members 30 onto the first surface of the mixed silicon 10 in the plurality of forming frames 20 respectively and removing the pressing members 30 from the first surface, thereby to form a three-dimensional pattern or shape in the mixed silicon, wherein the pressing member has the three-dimensional pattern or shape defined therein; (e) providing a form F having an inner space therein; (f) attaching the forming frames 20 onto the form F on an inner face of the form F; (g) filling a leveling material 50 into an inner face region of the form F in which the forming frame 20 is not attached, wherein a level of the leveling material 50 is substantially equal to that of the forming frame 20; (h) applying a concrete releaser onto an exposed inner face of the form F; (i) filling and curing a concrete into the inner space; (j) removing the form F from the cured concrete; and (i) removing the forming frames 20 from the form F, thereby to obtain a concrete structure having the three-dimensional pattern or shape formed therein.

The embodiment may further include, in addition to the operations as described with reference to FIG. 1 FIG. 2, filling a leveling material 50 into an inner face region of the form F in which the forming frame 20 is not attached, wherein a level of the leveling material 50 is substantially equal to that of the forming frame 20. Thus, the surface of the cured concrete in which the pattern or shape is formed may be flat.

In one example, the leveling material 50 may be made of a foam polystyrene. However, the present is not limited thereto.

While the forming frame(s) 20 and leveling material 50 are attached on the form F, a concrete may be filled into the form F and may be cured. In this connection, onto the surface of the forming frame 20 and leveling material 50, the concrete releaser may be applied, thereby to facilitate a separation between the concrete and the forming frame 20 and leveling material 50.

When a wall structure is newly formed, the frame 20 may be sandwiched between two forms F while one form F is spaced from the surface of the mixed silicon in which the pattern is formed. When a pattern or shape is formed into an existing wall structure, the form F may be adjacent to the wall while the wall is spaced from the surface of the mixed silicon in which the pattern is formed.

The forming frame 20 and leveling material 50 may be detached from the form F. The detached forming frame 20 may be cleaned and recycled.

The cured concrete surface with the pattern or shape formed therein may be polished using a sand paper or grinder. Thus, a color paint may be applied to the surface to impose a colorful pattern.

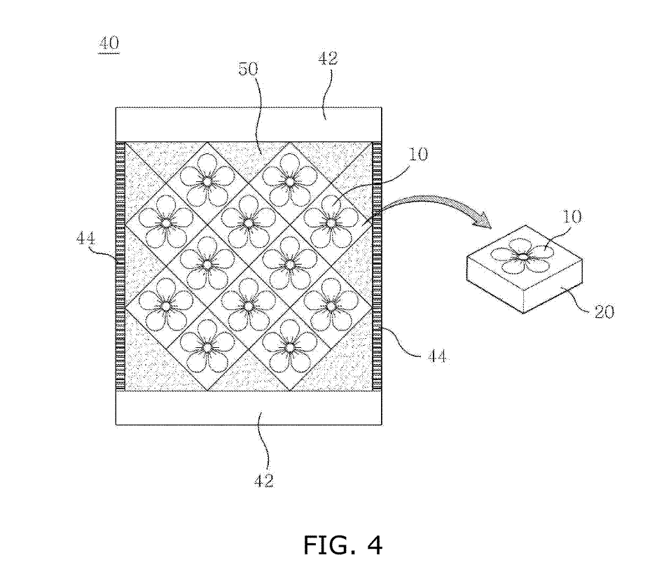

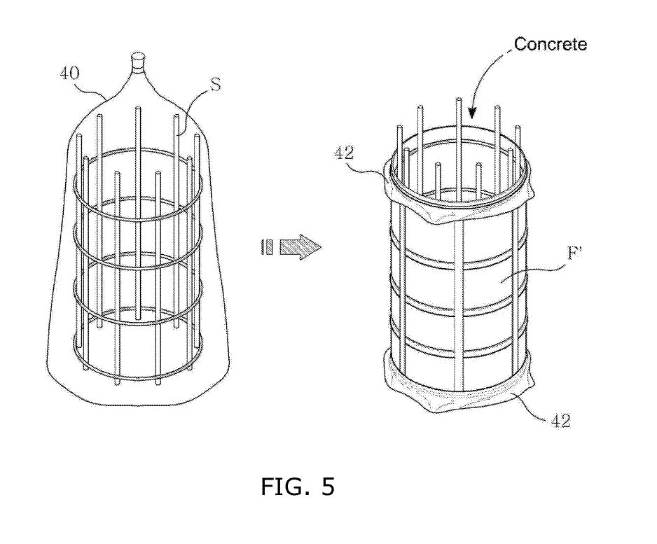

FIG. 4 and FIG. 5 show a process for forming a pattern or shape in a concrete pillar structure using a mixed silicon in accordance with one embodiment of the present disclosure.

In this embodiment, there is provided a method for forming a pattern or a shape in a concrete pillar structure, the method comprising: (a) mixing a cement about 100% by weight and silicon about 50% by weight to form a mixed silicon 10; (b) inserting the mixed silicon 10 into a forming frame 20; (c) applying a separating agent on a first surface of the mixed silicon 10 in the forming frame 20 wherein the first surface is exposed; (d) pressing a pressing member 30 onto the first surface and removing the pressing member 30 from the first surface, thereby to form a three-dimensional pattern or shape in the mixed silicon, wherein the pressing member has the three-dimensional pattern or shape defined therein; (e) providing a cover cloth 40 having top and bottom margins 42 extending beyond a top and bottom of the pillar structure respectively; (f) attaching the forming frame 20 onto the cover cloth 40; (g) providing a pillar forming framework S having a shape corresponding to a shape of the pillar structure; (h) wrapping the cover cloth 40 around the pillar forming framework S; (i) providing a pillar shaped form F′ around the cover cloth 40 wherein the pillar shaped form F′ contacts the cover cloth 40; (j) turning the top and bottom margins 42 inside out and fixing the top and bottom margins 42 to a top and bottom of the form F′ respectively; (k) filling and curing a concrete into the pillar forming framework S; and (l) removing the form F′ from the cover cloth 40 and then removing the cover cloth 40 from the forming frame 20 and then removing the forming frame 20 from the cured concrete, thereby to obtain the concrete pillar structure having the three-dimensional pattern or shape formed therein.

The cover cloth 40 may have a length substantially equal to a circumference of the pillar structure. The cover cloth 40 may have the top and bottom margins 42 extending beyond a top and bottom of the pillar structure respectively by about 30 cm. The forming frame 20 receiving therein the mixed silicon 10 may be attached to the cover cloth 40.

In one example, the mixed silicon 10 may be injected into a plurality of the forming frames 20 which, in turn, may be attached to the cover cloth 40.

In one example, a leveling material 50 may be filled into an inner face region of the cover cloth 40 in which the forming frame 20 is not attached, wherein a level of the leveling material 50 is substantially equal to that of the forming frame 20. Thus, the surface of the cured concrete in which the pattern or shape is formed may be flat.

The cover cloth 40 may have a pair of coupling means, each extending between the top and bottom of the cloth. The coupling means may include a zipper, Velcro, snap button, etc. Thus, the (h) operation may comprise wrapping the cover cloth 40 around the pillar forming framework S in an enclosing manner by the pair of coupling means being vertically coupled to each other.

As shown in FIG. 5, the cover cloth 40 may wrap the pillar forming framework S and then the top of the cover cloth 40 may be closed.

The pillar shaped form F′ may wrap and tightly contact the cover cloth 40. Then, the concrete may be filled into the pillar shaped form F′, more specifically, into the pillar forming framework S. Then, the concrete may be cured. Then, the pillar shaped form F′ may be removed from the mixed silicon 10. Then, the forming frames 20 may be removed from the cover cloth 40.

The top and bottom margins 42 may be turned inside out and may be fixed to a top and bottom of the form F′ respectively. The fixing may be achieved using a strap. This fixing may be necessary to prevent the movement of the cover cloth 40 due to a lateral pressure of the filled concrete.

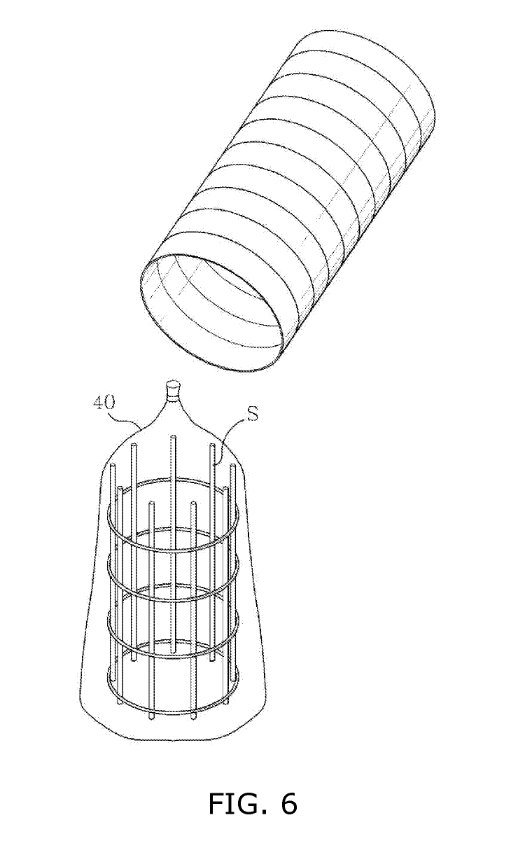

FIG. 6 shows a method for forming a pattern or shape in a concrete pillar structure using a mixed silicon in accordance with another embodiment of the present disclosure. The pillar shaped form F′ may be formed of a PVC tube or circular pipe. This may eliminate an assembly process of the conventional pillar shaped form F′. This may further facilitate the removal of the pillar shaped form F′ from the cover cloth 40, thereby to shorten the formation timing.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

1. A method for forming a pattern or a shape in a concrete wall structure, the method comprising:
(a) mixing a cement about 100% by weight and silicon about 50% by weight to form a mixed silicon;
(b) inserting the mixed silicon into a forming frame;
(c) applying a separating agent on a first surface of the mixed silicon in the forming frame wherein the first surface is exposed;
(d) pressing a pressing member onto the first surface and removing the pressing member from the first surface, thereby to form a three-dimensional pattern or shape in the mixed silicon, wherein the pressing member has the three-dimensional pattern or shape defined therein;
(e) providing a form for a concrete;
(f) attaching the forming frame onto the form;
(g) applying a concrete releaser onto a surface of the mixed silicon in which the shape or pattern is defined;
(h) placing and curing a concrete to the surface of the mixed silicon in which the shape or pattern is defined; and
(i) removing the mixed silicon from the cured concrete, thereby to obtain a concrete wall structure having the three-dimensional pattern or shape formed therein.

2. A method for forming a pattern or a shape in a concrete pillar structure, the method comprising:
(a) mixing a cement about 100% by weight and silicon about 50% by weight to form a mixed silicon;
(b) inserting the mixed silicon into a forming frame;
(c) applying a separating agent on a first surface of the mixed silicon in the forming frame wherein the first surface is exposed;
(d) pressing a pressing member onto the first surface and removing the pressing member from the first surface, thereby to form a three-dimensional pattern or shape in the mixed silicon, wherein the pressing member has the three-dimensional pattern or shape defined therein;
(e) providing a cover cloth having top and bottom margins extending beyond a top and bottom of the pillar structure respectively;
(f) attaching the forming frame onto the cover cloth;
(g) providing a pillar forming framework having a shape corresponding to a shape of the pillar structure;
(h) wrapping the cover cloth around the pillar forming framework;
(i) providing a pillar shaped form around the cover cloth wherein the pillar shaped form contacts the cover cloth;
(j) turning the top and bottom margins inside out and fixing the top and bottom margins to a top and bottom of the form respectively;
(k) filling and curing a concrete into the pillar forming framework; and
(l) removing the form from the cover cloth and then removing the cover cloth from the forming frame and then removing the forming frame from the cured concrete, thereby to obtain the concrete pillar structure having the three-dimensional pattern or shape formed therein.

3. The method of claim 2, wherein the cover cloth has a pair of coupling means, each extending between the top and bottom of the cloth, wherein the (h) comprises wrapping the cover cloth around the pillar forming framework in an enclosing manner by the pair of coupling means being vertically coupled to each other.

4. The method of claim 1, wherein the forming frame is made of an iron, wherein the forming frame has a cross-sectional shape including a polygonal shape.

5. The method claim 1, wherein the (b) comprises inserting the mixed silicon into a plurality of forming frames, wherein the (d) comprises pressing a plurality of pressing members onto the mixed silicon in the forming frames respectively, wherein the (f) comprises attaching the forming frames onto the form on the inner face of the form or the (f) comprises attaching the forming frames onto the cover cloth.

6. The method of claim 1, further comprising filling a leveling material into an inner face region of the form in which the forming frame is not attached, wherein a level of the leveling material is substantially equal to that of the forming frame.

7. The method of claim 5, further comprising filling a leveling material into an inner face region of the form in which the forming frames are not attached, wherein a level of the leveling material is substantially equal to that of the forming frame.

8. The method of claim 2, wherein the pillar shaped form is formed of a PVC tube or circular pipe.

9. The method of claim 2, wherein the forming frame is made of an iron, wherein the forming frame has a cross-sectional shape including a polygonal shape.

10. The method of claim 3, wherein the forming frame is made of an iron, wherein the forming frame has a cross-sectional shape including a polygonal shape.

11. The method claim 2, wherein the (b) comprises inserting the mixed silicon into a plurality of forming frames, wherein the (d) comprises pressing a plurality of pressing members onto the mixed silicon in the forming frames respectively, wherein the (f) comprises attaching the forming frames onto the form on the inner face of the form or the (f) comprises attaching the forming frames onto the cover cloth.

12. The method claim 3, wherein the (b) comprises inserting the mixed silicon into a plurality of forming frames, wherein the (d) comprises pressing a plurality of pressing members onto the mixed silicon in the forming frames respectively, wherein the (f) comprises attaching the forming frames onto the form on the inner face of the form or the (f) comprises attaching the forming frames onto the cover cloth.

13. The method of claim 2, further comprising filling a leveling material into an inner face region of the form in which the forming frame is not attached, wherein a level of the leveling material is substantially equal to that of the forming frame.

14. The method of claim 3, further comprising filling a leveling material into an inner face region of the form in which the forming frame is not attached, wherein a level of the leveling material is substantially equal to that of the forming frame.

15. The method of claim 3, wherein the pillar shaped form is formed of a PVC tube or circular pipe.
